(19) United States
(12) Patent Application Publication
(10) Pub. No.: US 2017/0015560 A1
(43) Pub. Date: Jan. 19, 2017

(54) GRAPHITE PLATE AND PRODUCTION METHOD THEREOF

(71) Applicant: Panasonic Intellectual Property Management Co., Ltd., Osaka (JP)

(72) Inventors: Naomi NISHIKI, Kyoto (JP); Kazuhiro NISHIKAWA, Osaka (JP); Hidetoshi KITAURA, Osaka (JP); Atsushi TANAKA, Osaka (JP); Kimiaki NAKAYA, Osaka (JP)

(21) Appl. No.: 15/206,262

(22) Filed: Jul. 9, 2016

(30) Foreign Application Priority Data
Jul. 16, 2015 (JP) 2015-141730
Apr. 15, 2016 (JP) 2016-081746

(51) Int. Cl. C01B 31/04

(52) U.S. Cl. CPC C01B 31/04; C01P 2006/32; C01P 2006/10

(57) ABSTRACT

A graphite plate has a surface roughness Ra from 10 μm to less than 40 μm and a surface-unevenness variation of 0.01% to 0.135% in any span 80 mm long within the surface of the graphite plate. A method for producing a graphite plate, includes r subjecting a polymer film to a heat treatment in an inert gas, wherein the heat treatment is conducted at 2400° C. to 3200° C., and a pressure of 10 kg/cm2 to 100 kg/cm² is applied to the polymer film at 200° C. or higher.

### TECHNICAL FIELD

The technical field relates to a graphite plate used as a heat-conductive material, and a production method thereof.

### BACKGROUND

As one example of a conventional method for obtaining a graphite plate with excellent heat conductivity, a polymer-graphitization method in which a polymer film is subjected to a heat treatment under an inert gas atmosphere such as nitrogen, argon or helium has been known (for example, see Japanese Patent Nos. 2057739 and 2975098, Publications).

Furthermore, as an example of a method for obtaining a graphite material that is used for gaskets, sliding members, crucibles, heating elements, etc., a method in which a kneaded mixture including a carbon material powder such as coke and a binding material such as tar and pitch is baked, and then, the mixture is heated so as to be converted into a graphite material has been known (for example, see Japanese Patent No. 5033325, Publication), although the produced graphite material has inferior heat conductivity.

Conventional graphite plates are flat and smooth materials that have glossy surfaces or frosted-glass-like non-glossy surfaces. Accordingly, when heat is conveyed from the graphite plates to other components, the contact areas therebetween becomes small, and the heat loss due to the contact thermal resistance is inevitable. Therefore, for example, heat-conductive pastes are coated onto surfaces of graphite plates, thereby improving their adhesiveness, and such materials are practically used.

### SUMMARY

However, since heat conductivities of the heat-conductive pastes are lower than that of graphite in the above-mentioned conventional arts, there is a problem that the heat conductivities of the resulting products are inferior.

Furthermore, when heat-conductive pastes are additionally used, there are also problems of increased numbers of required components, increased numbers of the production steps/increased amount of time required for the production, scattering of the pastes during the repair, and quality deterioration over time/due to the environment.

Hence, the purpose of the present application is to provide a graphite plate that does not require use of any heat-conductive pastes and that exhibits small contact thermal resistance, and a production method thereof.

In order to achieve the above-described purpose, provided is a graphite plate, having a surface roughness Ra from 10 μm to less than 40 μm, and a surface-unevenness variation of 0.01% to 0.135% in any span 80 mm long within the surface of the graphite plate. Furthermore, provided is a method for producing a graphite plate, including: subjecting a polymer film to a heat treatment in an inert gas, wherein the heat treatment is Conducted at 2400° C. to 3200° C., and a pressure of 10 kg/cm² to 100 kg/cm² is applied to the polymer film at 2000° C. or higher.

The graphite plate is capable of reducing the heat loss due to the contact thermal resistance -without using any heat-conductive pastes.

### BRIEF DESCRIPTION OF THE DRAWINGS

FIG. 1 is a cross-section, view of a heat-resistant vessel showing a state where a polymer film is placed in the vessel.

FIG. 2 is a cross-section view of a heat-resistant vessel showing a state in. which -multiple polymer films are tiered, in the heat-resistant vessel.

FIG. 3 is a diagram that shows a photo of a satin-like surface of a graphite plate, and results of its laser-based profilometry.

FIG. 4 is a diagram that illustrates a method for measuring a flatness.

FIG. 5 is a diagram that illustrates an experiment for comparing heat transfers.

FIG. 6 is a diagram that shows a relationship between flatness and surface roughness with regard to Examples and Comparative Examples.

FIG. 7 is a diagram that shows a relationship between heat conductivity and contact thermal resistance with regard to Examples and Comparative. Examples.

### DESCRIPTION OF EMBODIMENTS

Hereinafter, embodiments will be described with reference to drawings.

The graphite plate according to an embodiment is a graphite crystalline body that has a certain level of surface roughness (satin-like roughness) on its surface. Furthermore, in the production method thereof, one or more pieces of polymer films are graphitized in a state in which they are layered.

### Method for Producing a Graphite Plate

A method for producing a graphite plate using a polymer film as a material will specifically be described. A polymer film 3 described below is used as a material, and is kept inside a heat-resistant vessel 1 (as shown in FIG. 1) that has a heat resistance of 3200° C. or higher, and the vessel is heated. FIG. 1 is a cross-section view of the heat-resistant vessel 1 that is put into a furnace.

The polymer films 3, which serves as a material, is placed on the bottom of the heat-resistant vessel 1. While heating the heat-resistant vessel 1, the polymer film 3 is pressed by a block 2. As for the heating method, resistance heating, induction heating or the like can be used. An inert gas (argon, helium, nitrogen, etc. ) is used for the atmosphere. As a result, the polymer film 3 is turned into a graphite plate 5.

### Graphite Plate 5

The graphite plate 5 according to an embodiment has a structure in which hexagonal-mesh-like two-dimensional graphite crystals are layered. Accordingly, the graphite plate 5 has heat conductivities different between the surface direction and the thickness direction,
(1) Heat conductivity in the surface direction.

Since the heat is vibrationally conveyed therethrough, the graphite plate does not have a heat conductivity of 700 W/mK or higher if all of covalent bonds in the hexagonal-mesh-like structure are broken. Furthermore, when all of covalent bonds in the hexagonal-mesh-like structure remain intact, the graphite plate has a heat conductivity of 1500 W/mK. Consequently, the graphite plate 5 according to embodiments, which has a structure in which hexagonal-mesh-like two-dimensional graphite crystals are layered, may have a heat conductivity of 700 W/mK to 1500 W/mk in the surface direction.
(2) Heat conductivity in the thickness direction

Graphite crystals are connected to one another through the van der Waals' forces, and therefore, their connections are not rigid in the same manner as covalent bonds. Accordingly, the heat conductivity in the thickness direction is small. If all the connections through the van der Waals' forces are broken, the graphite plate does not have a heat conductivity of 2 W/mK or higher in the thickness direction. On the other hand, when all the connections remain intact, the graphite plate has a heat conductivity of 20 W/mK. Consequently, the graphite plate 5 according to embodiments, which has a structure in which hexagonal-mesh-like two-dimensional graphite crystals are layered, may have a heat conductivity of 2 to 20 W/mk in the thickness direction.
(3) Heat conductivities of graphite plates 5 according to embodiments

As a result of the above-mentioned features, a graphite plate 5 according to an embodiment may have a heat conductivity of 700 W/mK to 1500 W/mK in the surface direction, and a heat conductivity of 2 W/mK to 20 W/mK in the thickness direction.
(4) Density of the graphite plate 5

The density of the graphite plate 5 is also determined based upon a state of breakage of the crystal structure. The apparent density is 2.2 g/cm³ in a state where the covalent bonds and the connections through the van der Waals' forces remain intact. In a state where, while the covalent bonds and the connections through the van der Waals' forces are broken, the structure in which the crystals are layered is maintained, the density is 1.0 g/cm³. If the layer structure is broken, the density becomes smaller than 1.0 g/cm³ Accordingly, the graphite plate 5 according to an embodiment, which is a graphite crystal body, has a density of 1.0 g/cm³ to 2.2 g/cm³
(5) Thickness of the graphite plate 5.

A graphite plate 5 according to an embodiment may have a thickness of 2.5 μm to 2 mm. If the thickness of the graphite plate 5 is smaller than 25 μm, pressure cannot be evenly applied to the graphite plate 5, and the surface cannot be controlled. Consequently, in that case, the surface of the graphite plate 5 cannot be arranged in a satin-like fashion.

If the thickness of the graphite plate 5 is larger than 2 mm, it is difficult to remove a gas from a central portion thereof, and the surface cannot be arranged in a satin-like fashion while the overall crystallinity is maintained at a high level.

A graphite plate 5 according to an embodiment has a satin-like surface. This makes it possible to reduce the heat loss due to the contact thermal resistance against other components. Accordingly, it is not required to use any heat-conductive pastes, etc. serving as materials for reducing the contact thermal resistance, and the graphite plate 5 can be used even in the field of high-temperature industrial apparatuses in which heat-conductive pastes are deteriorated.

### Polymer Film 3 Serving as a Material

The polymer film, used as a material for the graphite plate 5 may be made of a polymer with a benzene ring, and examples thereof include polyimide, polyamide, polyoxadiazole, polybeneothiazole, polybenzobisthiazole, polybenzoxazole, polybenzobisoxazole, polyparaphenyienevinyiene, polyphenylene benzimidazole, polyphenylene benzbisimidazole, and polythiazole. The polymer film is preferably made of at least one polymer selected from these polymers. This is because, in that case, the resulting graphite plate 5 has enhanced heat conductivity.

The thickness of the polymer film used herein may be 2 μm to 150 μm, preferably 12 μm to 125 μm. If the thickness is smaller than 12 μm, wrinkles may easily be generated on the resulting graphite plate 5 due to static electricity. If the thickness is smaller than 2 μm, the surface of the resulting graphite plate 5 may be distorted by wrinkles. If the thickness is larger than 125 μm, the range of conditions for controlling elimination of a gas therefrom, may be narrow, and the control of the elimination of a gas may be difficult. If the thickness is larger than 150 μm, it may be impossible to eliminate a gas therefrom, and the surface of the resulting graphite plate 5 may be uneven.

In particular, a polymer film with a thickness of 25 μm to 75 μm hardly has wrinkles thereon, and it is easy to control elimination of a gas therefrom. Accordingly, in that case, it is easy to produce a homogenous graphite plate 5.

### Temperature for the Heat Treatment

The development of hexagonal-mesh-like two-dimensional crystals and the layer crystal structure of graphite is determined by a given temperature for the heat treatment. If the temperature is lower than 2400° C., the hexagonal mesh-like two-dimensional graphite crystals and the structure in which the two-dimensional crystals are layered cannot be produced, and therefore, such a temperature is unfavorable. In such a case, the transfer of atoms does not occur.

When the temperature for the heat treatment is 2600° C. or higher, the structure in which hexagonal-mesh-like two-dimensional graphite crystals are layered is produced as the whole, and therefore, such a temperature is preferable.

If the temperature for the heat treatment is higher than 3200° C., the graphite plate 5 starts to sublime, and therefore such a temperature is unfavorable.

As a result, it is required that the temperature for the heat treatment is within a range from 2400° C. to 3200° C. Furthermore, the temperature for the heat treatment is preferably 2600° C. or higher.

### Applying Pressure

The two-dimensional crystallization (crystallization in the surface direction) of the graphite plate 5 is a phenomenon that is caused on the scale of several hundred nanometers, and is determined mainly by the temperature for the heat treatment as described above.

Meanwhile, by applying pressure to the polymer film 3 during the heat treatment, the surface of the graphite plate 5 is folded on the micrometer scale. By controlling the surface of the graphite plate 5 so as to have such surface properties on the micrometer scale, the heat loss due to the contact thermal resistance is reduced.

The thermal resistance of the surface of the graphite plate 5 is reduced by controlling the surface properties of the graphite plate 5 to a certain range. The surface properties are described below, and are ascertained by referring to the section of Examples.

The surface roughness is 10 μm or higher and less than 40 μm, and the flatness is within a range from 0.01% to 0.135%.

When conventional graphite plates are produced, no pressure is applied thereto, or various types of pressure-applying methods are used. However, in the present embodiment, a pressure of 10 kg/cm² to 100 kg/cm² is applied to the surface of the graphite plate 5 in the vertical direction at. 2400° C. to 3200° C.

If the applied, pressure is lower than 10 kg/cm², the surface roughness becomes 40 μm or higher, and the flatness becomes larger than 0.135%.

If the applied pressure is higher than 100 kg/cm², the surface roughness becomes less than 10 μm, and the flatness becomes less than 0.01%.

By applying a pressure of 10 kg/cm² to 100 kg/cm² to the polymer film at 2400° C. to 3200° C. in the heat treatment, the surface roughness can foe adjusted to 10 μm or higher and less than 40 μm, and the flatness can be adjusted to 0.01% to 0.135%, thereby reducing the contact thermal resistance against other components.

In cases where the temperature for the heat treatment is lower than 2400° C., the surface of the polymer film 3 cannot foe controlled even if pressure is applied, to the polymer films 3.

In the process of the heat treatment, oxygen, nitrogen and hydrogen are eliminated from the polymer film 3, which is a compound of carbon, oxygen, nitrogen and hydrogen. Thus, only carbon is caused to remain therein, and carbon is caused to be recrystallized, and, consequently, a graphite plate 5 with high crystallinity can be obtained. If the graphite plate 5 does not have high crystallinity, it may not have a heat conductivity of 700 W/m to 1500 W/mK.

Since the elimination of oxygen, nitrogen and hydrogen is carried out in forms of gases, the surface of the material is distorted. By control ling the elimination, the surface can be formed in a satin-like fashion. If the applied pressure is lower, distortion of the surface of the material becomes larger. If the applied pressure is higher, the surface of the material becomes flat and smooth. In addition, if the pressure is applied, thereto at less than 2000° C., a homogenous graphite plate 5 may not be produced.

Heat energies affect, the material from the surface, so that there is a time lag between the recrystallizations in the surface and in the internal portion. Consequently, the surface can be formed in a satin-like shape while the overall crystallinity can be maintained at a high level.

With regard to the heat treatment of the polymer film 3, the temperature may be decreased once to room temperature between the step in which oxygen, nitrogen, and hydrogen are eliminated, therefrom and the step in which carbon is recrystallized, and thus, the heat treatment may be carried out twice in order to be increased.

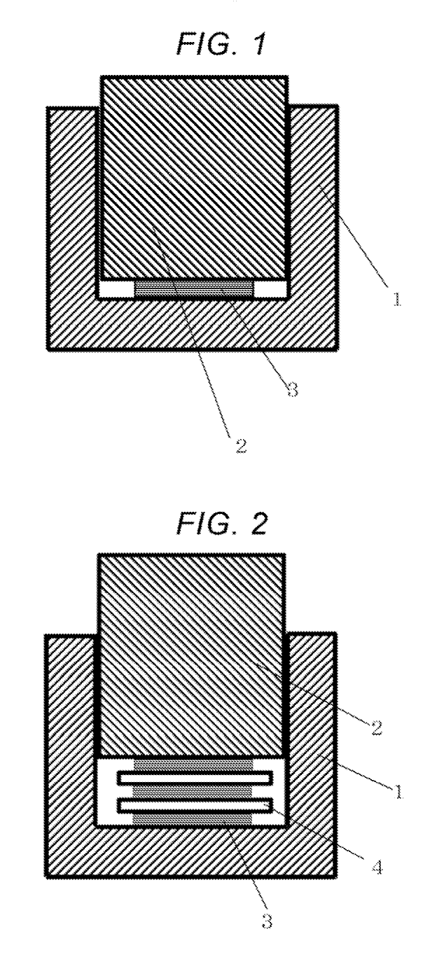

The polymer film(s) 3 is placed inside the heat-resistant vessel 1. In that case, in order to increase the number of the polymer films to be processed in each treatment, carbon plates 4 each having a thickness of about 5 mm may be placed between the polymer films 3 inside the heat-resistant, vessel 1 as shown in FIG. 2, and thus, these materials may be stacked in that way. FIG. 2 is a cross-section view of the heat-resistant, container 1 that is put into a furnace.

### Heat-Resistant Vessel 1 and Block 2

It is required that the heat-resistant vessel 1 and the block 2 are both resistant to a temperature of 3200° C. or higher and that they are materials that don't cause impurities. In addition to these requirements, it is required that they each have a structure that makes it possible to apply pressure to the polymer film(s) 3. Therefore, it is required that they bear a pressure of 100 kg/cm².

Shapes of the heat-resistant vessel 1 and the block 2 are not necessarily limited to a rectangular or round shape. It is required that there is no temperature variation inside the heat-resistant vessel 1, and the heat-resistant vessel 1 and the block 2 are preferably made of carbon not containing any impurities.

### Inert Gas

For the heat treatment, an inert gas is used in order to prevent, oxidation of the heat-treated material. For the inert gas, helium, nitrogen, and argon are preferable, and argon is particularly preferable. In order to prevent the air from penetrating into the furnace, the gas pressure is not limited as long as it is higher than the ordinary pressure. However, if the gas pressure inside the furnace, is higher than 0.2 MPa, the gases of oxygen, nitrogen and hydrogen, to be eliminated may be difficult to discharge therefrom. In addition, if the gas pressure inside the furnace is low, release of the gases to be eliminated rapidly occurs, resulting in breakage of the surface.

Moreover, even if the surface is not broken, generation of the gases to be eliminated becomes non-uniform, and the homogeneity may be impaired. Furthermore, the larger the thickness of the polymer film 3 used as a material, the more difficult it becomes for the gases to be eliminated to pass therethrough. Consequently, in that case, the resulting graphite plate is likely to have such a tendency of impaired homogeneity.

### EXAMPLES

As described below, samples were produced, and were evaluated. Conditions and results are shown in Table 1. However, those for Example 4 are not listed in Table 1 since the method for layering materials was only changed.

TABLE 1

| | | | | | Comparative | Comparative | Comparative | Comparative |
|---|---|---|---|---|---|---|---|---|
| | | Example 1 | Example 2 | Example 3 | Example 1 | Example 2 | Example 3 | Example 4 |
| Thicknesses of polymer films (μm) | | 25 | 50 | 75 | 25 | 50 | 75 | 75 |
| Pressures applied in the production (kg/cm²) | | 50 | 80 | 100 | 300 | 0 | 0 | 0 |
| Graphite | Thickness (mm) | 0.35 | 0.78 | 1.35 | 0.33 | 1.08 | 2.25 | 3.24 |
| plates | Apparent density (g/cm³) | 1.96 | 1.73 | 1.5 | 2.05 | 1.88 | 0.9 | 0.63 |
| | Heat conductivity (W/mk) | 1160 | 1030 | 900 | 1360 | 780 | 650 | 500 |
| | Surface roughness (μm) | 16.3 | 20.4 | 24.7 | 6 | 40 | 60 | 73 |
| | Flatness (%) | 0.04 | 0.06 | 0.09 | 0.01 | 0.145 | 0.18 | 0.195 |

| | | | | | | | |
|---|---|---|---|---|---|---|---|
| Contact thermal resistance (Temperature | 124 | 98 | 90 | 67 | 62 | 59 | 50 |
| indicated by the thermocouple) (° C.) | | | | | | | |
| Evaluation results | Excellent | Good | Good | Bad | Bad | Bad | Bad |

### Example 1

A polyimide film (Kapton 100H manufactured by DU PONT-TORAY CO., LTD,; thickness: 25 μm) was cut into pieces 100 mm square, and thirty of the pieces were stacked. The stacked pieces were put into the heat-resistant vessel 1 in FIG. 1, and were heated to 1000° C., at a rate of 1° C./minute within a range of 450° C. to 650° C., in an atmosphere of nitrogen gas, using an electric furnace. Subsequently, oxygen, nitrogen and hydrogen were eliminated, and then, while the materials were heated to 3000° C. at 10° C./minute in an atmosphere of argon gas, a pressure of 50 kg/cm² was applied thereto, thereby producing a graphite plate 5. The graphite plate 5 produced by this method had a surface roughness of 16.3 μm and a flatness of 0.040%. The heat conductivity thereof was 1160 W/mK. However, a thermocouple 6 indicated 124° C., and the sample was evaluated as “excellent.”

### Example 2

A polyimide film (Kapton 200H manufactured by DU PONT-TORAY CO., LTD.; thickness: 50 μm) was cut into pieces 100 mm square, and thirty of the pieces were stacked. The stacked pieces were put into the heat-resistant vessel 1 in FIG. 1, and were heated to 1000° C., at a rate of 1° C./minute within a range of 450° C. to 650° C., in an atmosphere of nitrogen gas, using an electric furnace. Oxygen, nitrogen and hydrogen were eliminated, and then, while the materials were heated to 3000° C. at 10° C./minute in an atmosphere of argon gas, a pressure of 80 kg/cm² was applied thereto, thereby producing a graphite plate 5. The graphite plate 5 produced by this method had a surface roughness of 19.5 μm and a flatness of 0.061%. The heat conductivity thereof was 1030 W/mK. The thermocouple 6 indicated 98° C., and the sample was evaluated as “good.”

### Example 3

A polyimide film (Kapton 300H manufactured by DU PONT-TORAY CO,, LTD.; thickness: 75 μm.) was cut into pieces 100 mm square, and thirty of the pieces were stacked. The stacked pieces were put into the heat-resistant vessel 1 in FIG. 1, and were heated to 1000° C., at a rate of 1° C./minute within a range of 450° C. to 650° C., in an atmosphere of nitrogen gas, using: an electric furnace. Oxygen, nitrogen and hydrogen were eliminated, and then, while the materials were heated to 3000° C. at 10° C./minute in an atmosphere of argon gas, a pressure of 100 kg/cm² was applied thereto, thereby producing a graphite plate 5. The graphite plate 5 produced by this method had a surface roughness of 24.7 μm and a flatness of 0.083%. The heat conductivity thereof was 900 W/mK. The thermocouple 6 indicated 90° C., and the sample was evaluated as “good.”

### Example 4

A polyimide film (Kapton 100H manufactured by DU PONT-TORAY CO., LTD.; thickness: 25 μm) was cut into pieces 100 mm square, and 3 sets of stacks each having thirty of the pieces were prepared. Four carbon plates each having a thickness of 5 mm were placed between them. The stack was put into the heat-resistant vessel 1, and was pressed with a block 2, as shown in FIG. 2. The stack was heated to 1000° C., at a rate of 1° C./minute within, a range of 450° C. to 650° C., in an atmosphere of nitrogen gas, using an electric furnace. Oxygen, nitrogen and hydrogen were eliminated, and then, while the materials were heated to 3000° C. at 10° C./minute in an atmosphere of argon gas, a pressure of 50 kg/cm² was applied thereto, thereby producing a graphite plate 5. The graphite plate 5 was subjected to the measurements. As a result, the graphite plate 5 had a heat conductivity of 1120 W/mK, a surface roughness of 16.0 μm, and a flatness of 0.045%. The thermocouple 6 indicated 109° C., and the sample was evaluated as “good.”

### Comparative Example 1

In accordance with the production method In Japanese Patent No. 2057739, a polyimide film (Kapton 100H manufactured by DU PONT-TORAY CO., LTD.; thickness: 25 μm) was cut into pieces 100 mm square, and thirty of the pieces were stacked. The stacked, pieces were put into the heat-resistant vessel 1 in FIG. 1, and were heated to 1000° C. in an atmosphere of nitrogen gas, using an electric furnace. Oxygen, nitrogen and hydrogen were eliminated, and then, the stack was heated to 3000° C. in an atmosphere of argon gas, and a pressure of 300 ,kg/cm² was applied thereto, thereby producing a graphite plate 5. The graphite plate 5 produced by this method had a surface roughness of 1.0 μm and a flatness of 0.005%, and the surface was glossy. The heat conductivity thereof was 1360 W/mK, and was thus higher than those of Examples 1 to 3. However, the thermocouple 6 indicated 67° C., and the sample was evaluated as “bad.”

It is considered that, since the surface was not formed in a satin-like shape, and contact points against the other component were few, the heat loss due to the contact thermal resistance was increased

### Comparative Example 2

In accordance with the production method in Japanese Patent No. 2975098, a polyimide film (Kapton 200H manufactured by DU PONT-TORAY CO., LID,; thickness: 75 μm) was cut into pieces 100 mm square, and thirty of the pieces were stacked. The stacked pieces were put into the heat-resistant vessel 1 in FIG. 1, and were heated to 1000° C. in an atmosphere of nitrogen gas, using an electric furnace. Oxygen, nitrogen and hydrogen were eliminated, and then, the stack was heated to 3000° C. in an atmosphere of argon gas without applying any pressure to the materials, thereby producing a graphite plate. The graphite plate produced by this method had a surface roughness of 40.0 μm and a flatness of 0.0145%, and the surface was a frosted glass like and non-glossy surface. The heat conductivity thereof was 780 w/mK the thermocouple 6 indicated 62° C., and the sample was evaluated as “bad.”

It is considered that the hexagonal-mesh like two dimensional crystal structure was broken in the resulting graphite plate. This is implied by the decreased heat conductivity. Furthermore, it is considered that, due to the breakage of the two-dimensional crystal structure, the graphite plate could not be in contact with the counterpart member while having sufficient elasticity.

### Comparative Example 3

In accordance with the production method in Japanese Patent No. 2975098 a polyamide film (Kapton 300H manufactured by DU PONT-TORAY CO., LTD.; thickness: 75 μm) was cut into pieces 100 mm square, and thirty of the pieces were stacked. The stacked pieces were put into the heat-resistant vessel 1 in FIG. 1, and were heated to 1000° C. in an atmosphere of nitrogen gas, using an electric furnace. Oxygen, nitrogen, and hydrogen were eliminated, and then, the stack was heated to 3000° C. in an atmosphere of argon gas without applying any pressure thereto, thereby producing a graphite plate. The graphite plate produced by this method had a surface roughness of 60.5 μm and a flatness of 0.18%, and the surface was a frosted-glass-like and non-glossy surface. The heat conductivity thereof was 650 W/mK, and was thus lower than those of Examples 1 to 3. The thermocouple 6 indicated 59° C., and the sample was evaluated as “bad.”

It is considered that the hexagonal-mesh-like two-dimensional crystal structure was broken in the resulting graphite plate. This is implied by the decreased heat conductivity. Furthermore, it is considered that, due to the breakage of the two-dimensional crystal structure, the graphite plate could not be in contact with the counterpart member while having sufficient elasticity.

### Comparative Example 4

In accordance with the production method In Japanese Patent No. 2975098, a polyimide film (Kapton 300H manufactured by DU PONT-TORAY CO., LTD.; thickness: 75 μm) was cut into pieces 100 mm square, and thirty of the pieces were stacked. The stacked pieces were put into the heat-resistant vessel 1 in FIG. 1, and were heated to 1000° C. in an atmosphere of nitrogen gas, using an electric furnace. Oxygen, nitrogen and hydrogen were eliminated, and then, the stack was heated to 3000° C. In an atmosphere of argon gas without applying any pressure to the materials, thereby producing a graphite plate. The graphite plate produced by this method had a surface roughness of 73.0 μm and a flatness of 0.195%, and the surface was a frosted-glass-like and non-glossy surface. The heat conductivity thereof was 500 W/mK, and was thus lower than those of Examples 1 to 3. The thermocouple 6 indicated 50° C., and the sample was evaluated as “bad.”

It is considered that the hexagonal-mesh-like two-dimensional crystal structure was broken in the resulting graphite plate. This is implied by the decreased heat conductivity. Furthermore, it is considered that, due to the breakage of the two-dimensional crystal structure, the graphite plate could not be in contact with the counterpart member while having sufficient elasticity.

### Evaluations on Graphite Plates 5

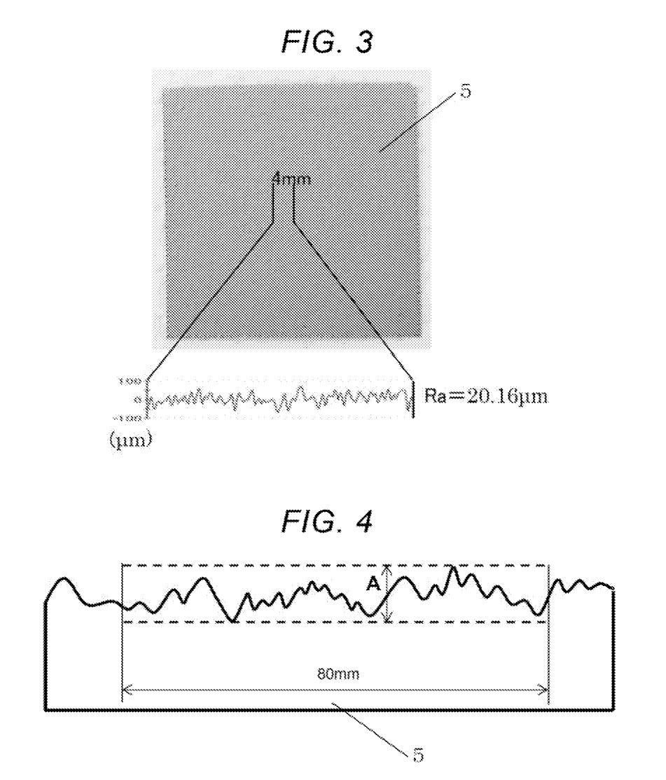

A photo of the surface of a graphite plate 5, laser-based profile(r)(c)try are shown in FIG. 3, With regard to the surface properties, the ranks were evaluated based on (1) surface roughness, (2) flatness, and (3) contact thermal resistance. That is, the evaluation was carried out based on (1) surface roughness, which corresponds to regular corrugation (2) flatness, which corresponds to irregular corrugation, and (3) contact thermal resistance, which is a resulting thermal property. To reduce the thermal contact resistance (3) of the surface, surface properties of both of (1) and (2) are required.
(1) Evaluations on surface roughness

Surface roughness was evaluated based on Ra (arithmetic mean roughness) in the JIS standard.
(2) Definition of the flatness

FIG. 4 shows a cross-section of the graphite plate 5. A percentage of a value obtained by dividing, by 80 mm, a difference A mm between the largest height and the smallest height within a span of 80 mm refers to a flatness.
(3) Evaluations on contact thermal resistance

The cross-sectional structure shown in FIG. 5 was used in order to evaluate effects of heat transfer due to reduced contact thermal resistance. A graphite plate 5 of 100 mm×30 mm with a thermocouple 6 attached to its edge was prepared. A copper block 7 of 30 mm. square, which was heated to 300° C., was placed in a position opposite to the position, that the thermocouple 6 was attached to, and the temperature was measured with the thermocouple 6 when 5 seconds passed. When the contact heat resistance was small, the heat transfer was fast, and the temperature measured with the thermocouple 6 elevated fast. For the evaluation, when the temperature indicated by the thermocouple 6 was 110° C. or higher, the sample was evaluated as “excellent”; when the temperature was from 90° C. to less than 110° C., the sample was evaluated as “good”; when the temperature was from 70° C. to less than 90° C., the sample was evaluated as “fair”; and when the temperature was less than 70° C., the sample was evaluated as “bad.”

### RESULTS

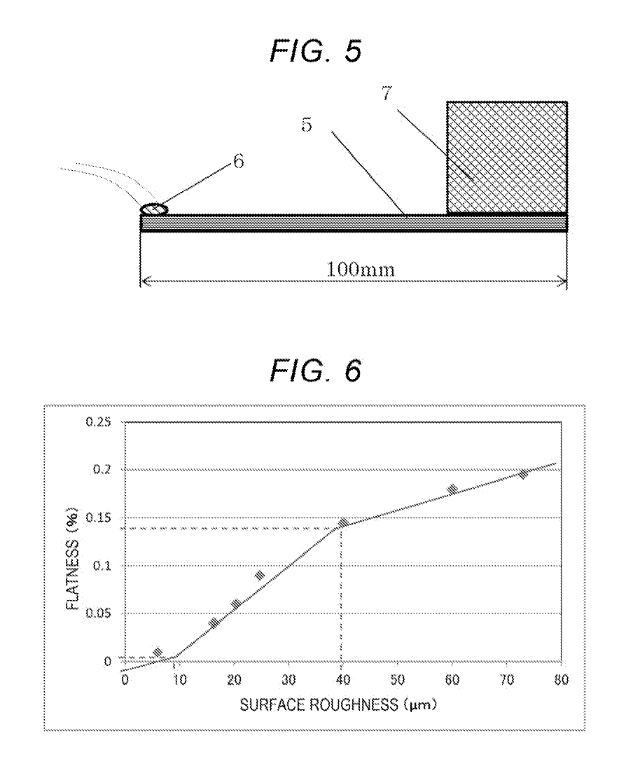

Results of Examples 1 to 3 and Comparative Examples 1 to 4 are summarized in the graph of FIG. 6. In FIG. 6, the vertical axis indicates the flatness while the horizontal axis indicates the surface roughness. The surface roughness refers to average corrugation, and the flatness refers to corrugation where there are the most drastic variations. Therefore, there is no direct correlation between the surface roughness and the flatness.

However, in the materials used herein, only within a certain, range, there is a proportional relationship between the surface roughness and the flatness. Furthermore, properties of the contact thermal resistance within that range is preferred.

Based on the graph, a region where the surface roughness is from. 10 μm to less than 40 μm and the flatness is from 0.010% to 0.135% is a discontinuous area (specific or critical area) to the other area. Furthermore, a region of examples where the surface roughness is from 16.3 μm to 24.7 μm and the flatness is from 0.04% to 0.09% is preferable,

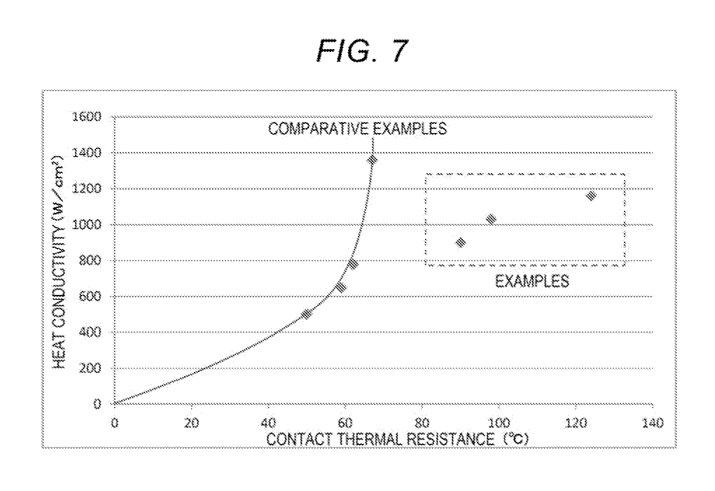

Furthermore, a relationship between the contact thermal resistance and the heat conductivity is shown in FIG. 7. In the comparative examples, when the heat conductivity was high, the contact thermal resistance did not exceed a certain level. it is considered that the contact properties were inferior although the heat transmission rates were sufficient since the crystallinity of the graphite became high. On other hand, in examples, since the surface roughness and the flatness were within the region shown in FIG. 6, the heat conductivities were consequently increased to certain levels and the contact thermal resistance was also enhanced. Accordingly, the samples in the examples had high performance in depriving heat from objects, thus transmitting the heat therethrough. In examples, due to synergistic effects by the surface roughness and the flatness, critical phenomena occurred, compared with the comparative examples. Such phenomena are unpredictable.

In addition, this is not associated with the thickness of the graphite plate 5.

The graphite plate according to the embodiments can be a heat-conductive material used inside high-performance and downsized electronic devices, and can particularly be used in notebook computers, tablets, smartphones, portable phones, wearable devices, digital cameras, and digital movie cameras. Furthermore, the graphite plate can be used In industrial apparatuses that exceed the limit of heat resistance of heat-conductive pastes, which are used in order to reduce the heat loss due to the contact thermal resistance, outdoor-use devices that ultraviolet rays penetrate into, etc.

What is claimed is:

1. A graphite plate., having, a surface roughness Ra from 10 μm to less than 40 μm, and a surface-unevenness variation of 0.01% to 0.135% in any span 80 mm long within the surface of the graphite plate.

2. The graphite plate according to claim 1, wherein the graphite plate has a thickness of 25 μm to 2 mm, and is obtained by subjecting to a heat treatment one piece of a polymer film having a thickness of 25 μm to 150 μm, or multiple pieces of the polymer film that are layered.

3. The graphite plate according to claim 1, the graphite plate having a heat conductivity of 700 W/mK to 1500 W/mK in the surface direction, and a density of 1.0 g/cm³ to 2.2 g/cm³.

4. The graphite plate according to claim 1, the graphite plate having a heat conductivity of 2 W/mK to 20 W/mK in the thickness direction, and a density of 1.0 g/cm³ to 2.2 g/cm³.

5. A method for producing a graphite plate, comprising: subjecting a polymer film to a heat treatment in an inert gas, wherein the heat treatment is conducted, at 2400° C. to 3200° C., and a pressure of 10 kg/cm² to 100 kg/cm² is applied to the polymer film at 2000° C. or higher.

6. The method for producing a graphite plate according to claim 5, wherein the polymer film is made of a condensation-based polymer such as polyimide, polyamide, polyoxadiazole, polybenzothiazole, polybenzobisthiazole, polybenzoazole, polybenzobisoxazole, polyparaphenylenevinylene, polyphenylene benzimidazole, polyphenylene benzbisimidasole, and polythiazole.
